(19) United States
(12) Patent Application Publication
(10) Pub. No.: US 2010/0128861 A1
(43) Pub. Date: May 27, 2010

(54) DATABASE FAILURE DETECTION AND RECOVERY FOR CALL MANAGEMENT SYSTEM

(75) Inventors: Vlad Vendrow, Redwood Shores, CA (US); Bruce Young, San Jose, CA (US); Praful Shah, Los Altos Hills, CA (US); Boris Elpiner, Sunnyvale, CA (US); Vladimir Shmunis, Hillsborough, CA (US)

Correspondence Address: FISH & RICHARDSON P.C., PO BOX 1022, MINNEAPOLIS, MN, 55440-1022, US

(73) Assignee: RingCentral, Inc., San Mateo, CA (US)

(21) Appl. No.: 12/626,168

(22) Filed: Nov. 25, 2009

Related U.S. Application Data
(60) Provisional application No. 61/117,871, filed on Nov. 25, 2008.

(51) Int. Cl. H04M 15/00; H04M 3/00

(52) U.S. Cl. 379/114.01; 379/265.02

(57) ABSTRACT

Methods, systems, apparatus and computer program products for managing calls using a call management system are described. The call management system can receive a call from a communication device and directs the call to a call database containing configuration information for supporting outbound calls. If the call management system detects or obtains notification of a failure associated with the call database, the system automatically bypasses the call database and makes the outbound call using default configuration and call routing information. A second or backup database is used to log call details which can be copied or moved to the call database after the call database is back in service.

### CROSS-REFERENCE TO RELATED APPLICATION

This application claims the benefit of priority to U.S. Provisional Application Ser. No. 61/117,871 titled “DATABASE FAILURE DETECTION AND RECOVERY FOR CALL MANAGEMENT SYSTEM”, filed on Nov. 25, 2008, the disclosure of which is incorporated herein by reference in its entirety.

### TECHNICAL FIELD

This subject matter is generally related to managing calls for communication devices.

### BACKGROUND

A private branch exchange (PBX) is a telephone network that serves a business or an office. A virtual PBX (vPBX) allows a business or office to be served by a PBX system hosted on remote servers. The service is provided through a combined voice network (e.g. telephone network) and data network (e.g. Internet). Conventional vPBX systems rely on a database to support outbound calls. If the database fails, subscribers may be denied service entirely until the database is repaired and restored.

### SUMMARY

Methods, systems, apparatus and computer program products for managing calls using a call management system are described. The call management system can receive a call from a communication device and directs the call to a call database containing configuration information for supporting outbound calls. If the call management system detects or obtains notification of a failure associated with the call database, the system automatically bypasses the call database and makes the outbound call using default configuration and call routing information. A second or backup database is used to log call details which can be copied or moved to the call database after the call database is back in service.

In some implementations, a method can be used that includes receiving a request to establish a call; identifying a call database containing call information supporting the call; determining an availability of the call database; and establishing the call without accessing the call information in the call database if it is determined that the call database is unavailable.

In some implementations, a system can be used that includes a telephone gateway server to receive one or more requests to establish one or more calls; a call database containing call information supporting the one or more calls; and a fault monitor server to detect one or more errors at the call database and to communicate the one or more identified errors to the telephone gateway server, where the telephony gateway server establishes the one or more calls without accessing the call information in the call database if the fault monitor server detects one or more errors at the call database.

In some implementations, a device can be used that includes a call database that stores call information supporting one or more calls; and a call control manager that: receives the one or more requests to establish the one or more calls; determine the availability of the call database; and establish the one or more calls without accessing the call information in the call database if the call database is unavailable.

Other implementations are disclosed which are directed to systems, methods and computer-readable mediums. The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 shows an example of a call management system.

FIG. 2 shows an example of a call control manager.

FIG. 3 shows an example of a mobile device.

FIG. 4 shows an example of a process for bypassing a failed call database in a call management system.

FIG. 5 shows an example of a call database bypass system for detecting and handling a call database failure.

FIG. 6 is a block diagram of two exemplary generic computing devices that can be used to implement processes and methods described in relation to the call management system shown in FIG. 1.

Like reference symbols in the various drawings indicate like elements.

### DETAILED DESCRIPTION

### Call Management System Overview

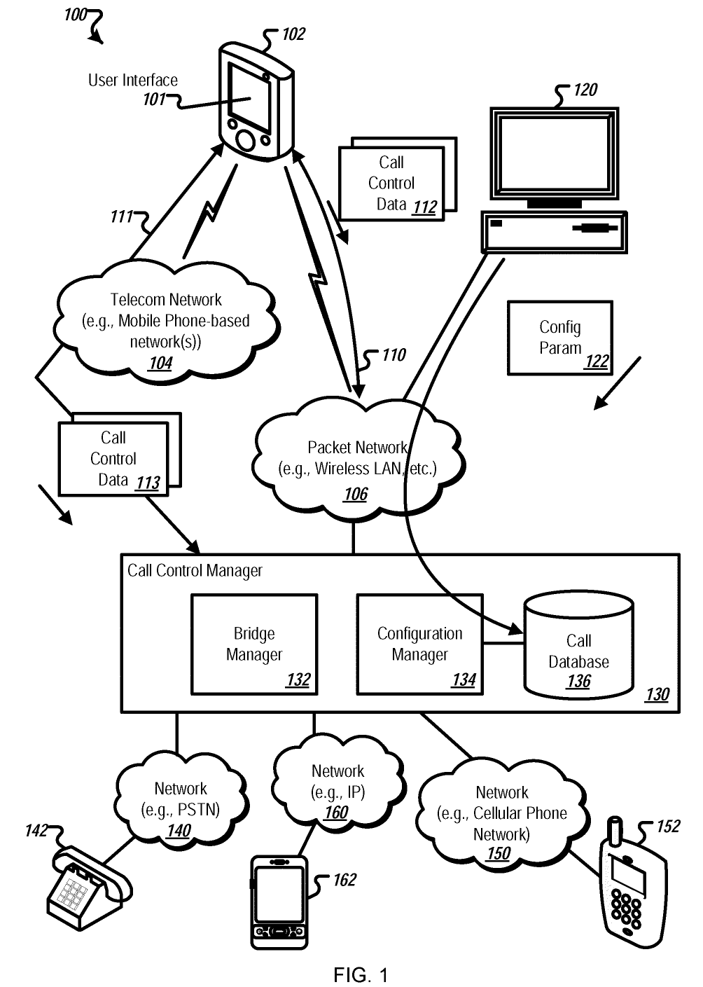

FIG. 1 shows an example of a call management system 100. As shown in FIG. 1, the mobile device 102 can be connected to a telecommunication (“telecom”) network 104 and a packet network 106. The mobile device 102 can be configured to communicate with devices connected to the telecom network 104 and the packet network 106 using multiple modes of communication (i.e., “multi-modal channels of communication”).

In some implementations, the telecom network 104 and the packet network 106 can each operate in a same or different mode of communication. For example, the telecom network 104 can operate in accordance with a first mode of communication. Examples of the first mode of communication can include Public Switched Telephone Network (“PSTN”) phone modes, cellular/wireless telephone technology modes, such as Global System for Mobile communications (“GSM”), Frequency Division Multiple Access (“FDMA”), Time Division Multiple Access (“TDMA”), Code Division Multiple Access (“CDMA”), and the like.

The packet network 106 can operate in accordance with a second mode of communication. The second mode of communication can be the same or different. Examples of a different second mode of communication include Voice over Internet Protocol (VOIP) modes, wireless LAN modes (e.g., telephone technologies/standards, such as WiMAX and any other IEEE 802.xx-based modes), and the like. Any number of modes is possible.

A call manager 130 can be coupled to the mobile device 102 through the telecom network 104 or the packet network 106. For example, the mobile device 102 can be configured to interact with the call control manager 130 over a call control communications channel. In some implementations, the call communications channel can include a broadband call control channel 110, and the broadband call control channel 110 can be established with the packet network 106 (e.g., in the same or separate channel used to convey voice/video data, such as in a Session Initiation Protocol (“SIP”) message).

In some implementations, the call communications channel also can include a narrowband call control channel 111, and the narrowband call control channel 111 can be established with the telecom network 104 (e.g., a mobile operator can be provided in the same or separate channel used to convey voice/video data, such as in an Short Message Service (“SMS”) message). The mobile device 102 and/or the call control manager 130 can be configured to transmit and/or receive call control data 113 and call control data 112 over the narrowband call control channel 111 and over the broadband call control channel 110, respectively. The call control manager 130 can be configured to effect a number of call controlling functions that can be performed remotely from the mobile device 102. For example, the call control manager 130 can perform call control operations in association with a first call from a communications device 142 via a PSTN network 140, a second call from a communications device 152 via an internet protocol (IP) network 150, and/or a third call from a communications device 162 via a cellular phone network 160.

In some implementations, the call control manager 130 can be disposed in a central office (“CO”). In some implementations, the mobile device 102 can include an interface 101 (e.g., a user interface) for facilitating the generation, receipt, processing, and management of the call control data 112 and 113 for delivery over the narrowband call control channel 111 and/or the broadband call control channel 110. The interface 101 can be configured to implement the functionalities described herein, including receiving inbound calls, dialing outbound calls, and other functions.

In some implementations, the call control manager 130 can include a bridge manager 204, a configuration manager 134, and a call database 136. The bridge manager 204 can be configured to perform, without limitation, inbound call delivery, call routing, call transfer functions, conference call functions for the mobile device 102. For example, an inbound missed call can be recorded (e.g., voice mail) on the mobile device 102 and/or on the call control manager 130 and simultaneously reviewed on the mobile device 102 via the interface 101. During call recording, the call manager 130 can allow the inbound call to be answered dynamically at the mobile device 102 and/or transferred to one of the communications devices 142, 152, and 162. Completed recordings (e.g., announcements, voice mail, etc.) can be reviewed at the mobile device 102 via the interface 101.

The configuration manager 134 can be configured to interact with a remote computing device 120 or with the mobile device 102 to receive configuration parameter data (“conf param”) 122. The configuration manager 134 can store the configuration parameter data 122, and responsive to such data, the call control manager 130 can control inbound calls before, during, or after reaching the mobile device 102. The configuration manager 134 also can be configured to store in the call database 136 audio files recorded through the interface 101 on the mobile device 102, and transmit the stored files to the mobile device 102 using the narrowband call control channel 111 and/or the broadband call control channel 110.

### Call Manager

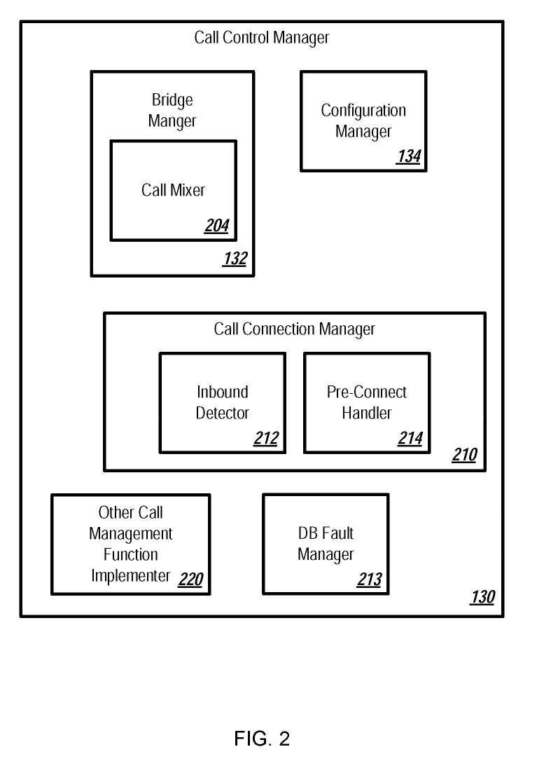

FIG. 2 shows an example of a call control manager 130. Referring to FIG. 2, the call control manager 130 can include a bridge manager 132, a configuration manager 134, a call connection manager 210, a database (DB) fault manager 213, and a call management function 220 configured to implement one or more call control function described herein.

The bridge manager 132 also can include a call mixer 204. In some implementations, the call mixer 204 can be configured to combine calls using various telecommunication technologies and protocols. The call mixer 204 can use different CODECs to implement the various telecommunication technologies and protocols. In some implementations, the mixer 204 can reside in the mobile device 102. In some implementations, the mixer can be external to the mobile device 102.

The call connection manager 210 can include an inbound detector 212 and a pre-connect handler 214. The inbound detector 212 can detect a call from any communications device (e.g., communications devices 142/152/162 shown in FIG. 1) and determine whether a communication link to the mobile device 102 via the packet network 106 of FIG. 1 can be established. For example, the inbound detector 212 can communicate with the mobile device 102 to determine whether a data rate of more than, for example, 8 kb/sec is obtainable. If the specified data rate is not practicable, the inbound detector 212 can provide a course of action (e.g., directing the call to the user's voicemail) until the specified data rate is above an acceptable threshold.

In some implementations, the call control data 112 can contain one or more call-related (or non-call related) instructions related to handing one or more calls from the communications devices 142/152/162. In some implementations, the pre-connect handler 214 can interact with the mobile device 102 to receive these instructions before establishing a connection with the communications devices 142/152/162.

Similarly, the call control data 113 can contain one or more call-related (or non-call related) instructions related to handing one or more calls from the communications devices 142/152/162. In some implementations, the call control data 113 can be incorporated into an SMS message (or any other type of messaging protocol) that can be sent to the control manager 130 using the telecom network 104. For example, the mobile device 102 can generate the call control data 113, and the call control data 113 can include an instruction that instructs the call control manager 130 to transmit a message to the communications devices 142/152/162. An example of such a message can include, for example, “I am out of wireless LAN range. I will call you later when I can make a VOIP call.” Any of the components of the call control manager 130 can be implemented in hardware or software, or a combination thereof.

### Mobile Device Implementation

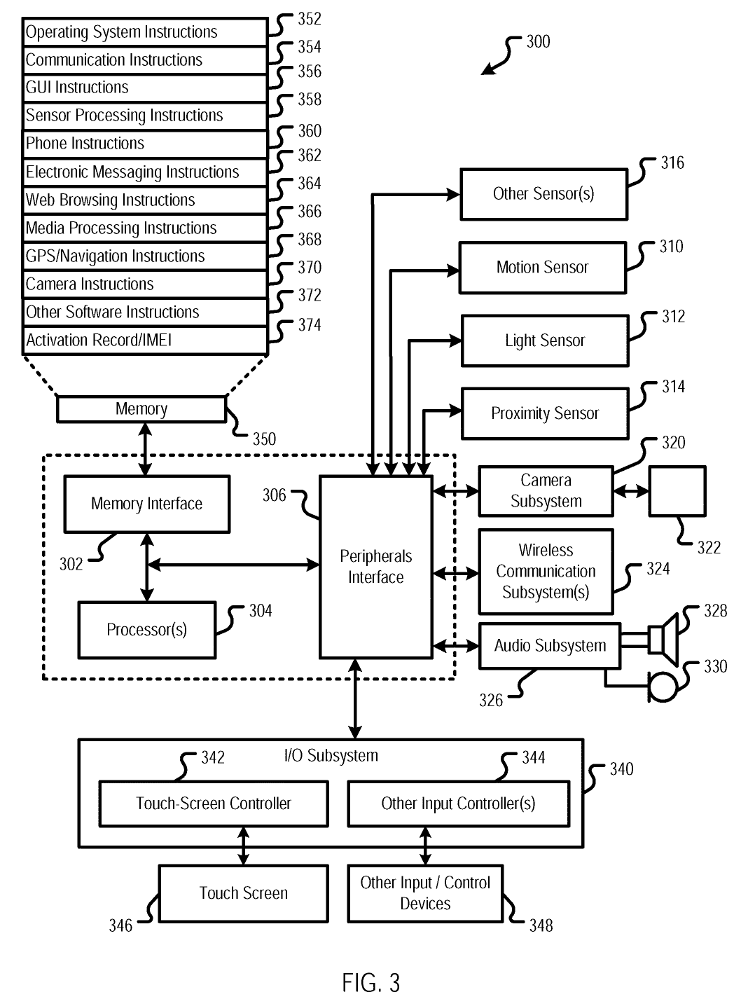

FIG. 3 shows an example of a mobile device 300. The mobile device 300 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate orientation, lighting, and proximity functions. Other sensors 316 also can be connected to the peripherals interface 306, such as a positioning system (e.g., GPS receiver), a temperature sensor, a biometric sensor, or other sensing device, to facilitate related functionalities.

A camera subsystem 320 and an optical sensor 322 (e.g., a charged coupled device (“CCD”) or a complementary metal-oxide semiconductor (“CMOS”) optical sensor) can be utilized to facilitate camera functions, such as recording photographs and video clips.

Communication functions of the mobile device 300 can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device is intended to operate. For example, a mobile device can include communication subsystems 324 designed to operate over a GSM network, a GPRS network, an EDGE network, a Wi-Fi or WiMax network, and a Bluetooth™ network. In particular, the wireless communication subsystems 324 can include hosting protocols such that the mobile device can be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as, without limitation, one or more buttons, rocker switches, thumb-wheel, infrared port, USB port, and/or a pointer device such as a stylus. The one or more buttons (not shown) can include an up/down button for volume control of the speaker 328 and/or the microphone 330.

In some implementations, a pressing of the button for a first duration can disengage a lock of the touch screen 346, and a pressing of the button for a second duration that is longer than the first duration can turn power to the mobile device 300 on or off. The user can customize the functionality of the buttons in any desirable manner. The touch screen 346 also can be used to implement virtual or soft buttons and/or a keyboard.

In some implementations, the mobile device 300 can present recorded audio and/or video files, such as, without limitation, MP3, AAC, and MPEG files. In some implementations, the mobile device can include the functionality of an MP3 player.

The memory interface 302 can be coupled to the memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as, without limitation, Darwin, RTXC, LINUX, UNIX, OS X, WINDOWS, or an embedded operating system such as VxWorks. The operating system 352 can include instructions for handling basic system services and for performing hardware dependent tasks. In some implementations, the operating system 352 can be a kernel (e.g., UNIX kernel).

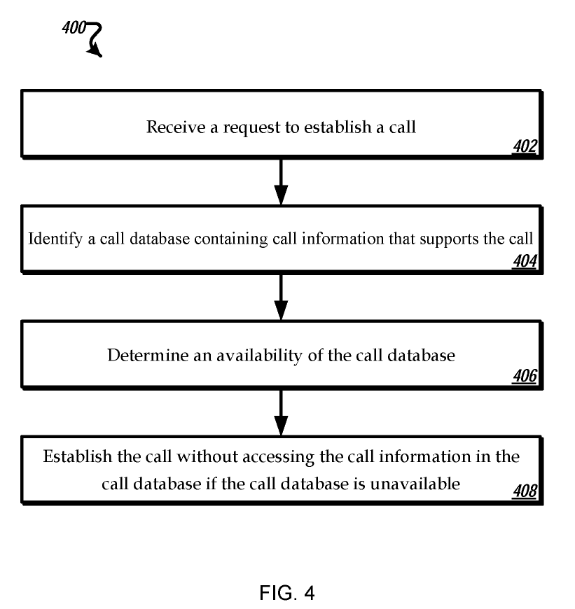

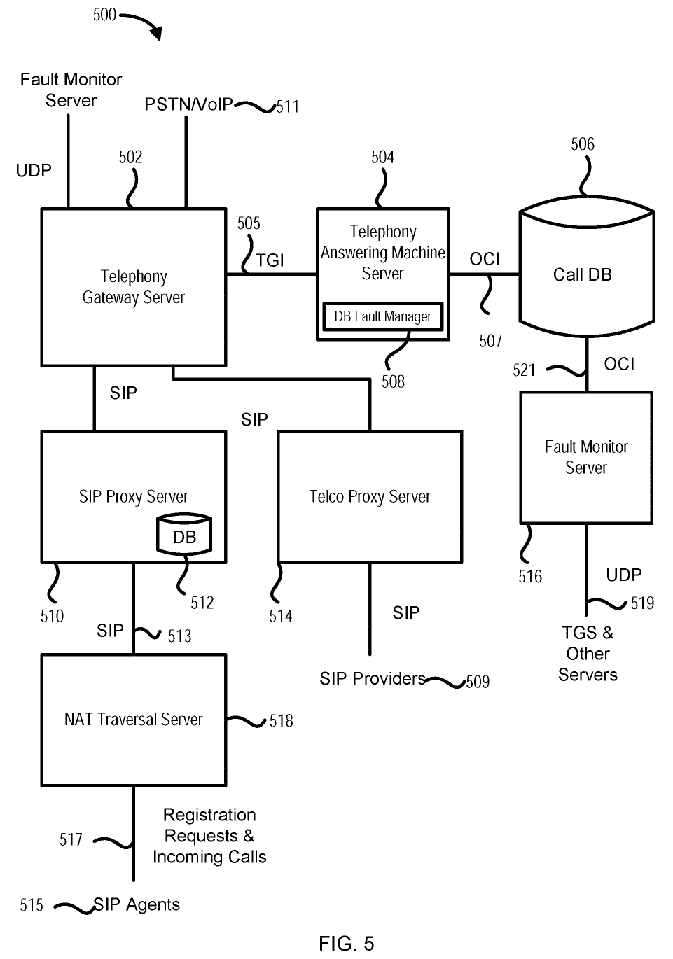

The memory 350 can also store communication instructions 354 to facilitate communicating with one or more additional devices, one or more computers and/or one or more servers. The memory 350 can include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions (e.g., access control management functions as will be described in reference to FIGS. 4 and 5).

The memory 350 also can store other software instructions (not shown), such as web video instructions to facilitate web video-related processes and functions, and/or web shopping instructions to facilitate web shopping-related processes and functions. In some implementations, the media processing instructions 366 can be divided into audio processing instructions and video processing instructions to facilitate audio processing-related processes and functions and video processing-related processes and functions, respectively. An activation record and International Mobile Equipment Identity (“IMEI”) 374 or similar hardware identifier also can be stored in the memory 350.

Each of the above identified instructions and applications can correspond to a set of instructions for performing one or more functions described above. These instructions need not be implemented as separate software programs, procedures, or modules. The memory 350 also can include additional instructions or fewer instructions. Furthermore, various functions of the mobile device 300 can be implemented in hardware and/or in software, including in one or more signal processing and/or application specific integrated circuits.

### Example Failure Recovery Process

FIG. 4 shows an example of a process 400 for bypassing a failed database in a call management system. In some implementations, the process 400 can be used to ensure that a communication device can register and make outbound calls in the event of a call database failure.

Process 400 begins with receiving a request to establish or connect a call. (402). In some implementations, the request can include a number associated with multiple extensions. For example, a user can call 1-800-XXX-XXXX which can be linked to one or more extensions each connected to a same or different communications device (e.g., cellular phones, IP phones and the like).

A database containing call information that supports the call can be identified (404). For example, a call control manager (e.g., call control manager 130) can identify the call database 136 as the database that contains call information that supports the call, and attempt to access the call database 136 to retrieve the call information. The call database 136 can store, without limitation, one or more extensions (or telephone numbers) associated with the 1-800-XXX-XXXX number, audio prompts, configuration data, call routing rules, call detail records, billing information, and other information.

The availability of the database can be determined (406). In some implementations, a failure or one or more errors at the database can be detected. For example, the call control manager 130 can detect a failure or one or more errors at the call database 136. When the call database 136 is down or otherwise cannot be accessed, the call control manager 130 can be prevented from retrieving or accessing the call information needed in the call database 136 to complete the call. A variety of events can give rise to a call database failure. For example, database errors, timeouts, and failover attempts (e.g., failover attempts above a certain threshold) can lead to the detection of a call database failure.

In some implementations, the database failure can be detected by a fault monitor server (e.g., fault monitor server 516 shown in FIG. 5). The fault monitor server can then notify a telephony gateway server (e.g., telephony gateway server 502 shown in FIG. 5) of the failure. In some implementations, the telephony gateway server can be informed of the failure prior to receiving a request to establish a call.

If it is determined that the database is unavailable, the call can be established or completed without accessing the call information in the call database (408). For example, in response to the detected failure (or notification of a call database failure), the call database 136 can be bypassed. In this example, if a failure is detected at the call database 136, the call control manager 130 can automatically bypass the failed call database 136. In some implementations, the call control manager 130 can execute a database management script (e.g., a shell script) to automatically bypass the failed call database 136.

In some implementations, the call control manager 130 and the telephony gateway server can establish the call using default configuration and call routing information without accessing information stored in the call database 136.

In some implementations, data related to the call can be logged in a different database. For example, a call detail record (“CDR”) can be created and logged in a different database or backup database. In some implementations, the CDR can include, without limitation, a calling number, destination number, call duration, call/hang-up time and other information. In some implementations, upon repairing and/restoring the failed call database, the CDR information can be forwarded (e.g., copied or moved) to the once-failed database (e.g., call database 136). In some implementations, the CDR information is forwarded only when the call database has been restored (or becomes available again).

### Call Database Bypass System

FIG. 5 shows an example of a call database bypass system 500 for detecting and handling a call database failure. In some implementations, the call database bypass system 500 can include a telephony gateway server (“TGS”) 502, a telephony answering machine (“TAM”) server 504, a call database 506 (e.g., Oracle® 10g), a SIP proxy server 510, a telco proxy server 514, a fault monitor server 516 and a Network Address Translation (“NAT”) traversal server 518. In some implementations, the TAM server 504 can include a database fault manager 508 to implement or execute the process 400 shown in FIG. 4. The call database bypass system 500 is one possible configuration and merely illustrative, and other configurations are also possible including configurations with a greater or lesser number of servers or databases than those shown in FIG. 5.

Referring to FIG. 5, the NAT traversal server 518 can receive information associated with registration requests and incoming calls 517 from one or more SIP agents 515 (e.g., mobile phones, soft phones, IP phones and the like). The NAT traversal server 518 can be an outbound proxy for the SIP agents 515 that establishes and maintains TCP/IP network connections with the SIP agents 515. Based on the information associated with the registration requests and incoming calls 517 received from the SIP agents 515, the NAT traversal server 518 can generate corresponding SIP information 513, and forward the SIP information to the SIP proxy server 510. The SIP proxy server 510 can handle SIP agent registration, and function as a SIP proxy for calls to/from the SIP agents 515.

In some implementations, though not shown, the SIP proxy server 510 can include an active SIP proxy server and a standby SIP proxy server. In some implementations, if the active proxy has failed, then the standby proxy can automatically be activated. Load balancing also can be implemented on the SIP proxy server 510 to forward the one or more incoming calls from the SIP agents 515 to the TGS 502.

The TGS 502 can receive one or more incoming calls from the SIP proxy server 510. The TGS 502 also can receive and establish calls from/to the public switched telephone network 511 (PSTN) or VoIP. VoIP calls can include calls to and from VoIP providers or to/from the SIP agents 515.

The TGS 502 also can be connected to the telco proxy server 514. The telco proxy server 514 can handle calls from and to the SIP providers 509, and redirect the calls to the TGS 502. In some implementations, the telco proxy server 514 can use the same load balancing as the SIP proxy server 510 for incoming calls.

The TAM server 504, which can include the database default manager 508, can include business logic, and communicate with the call database 506 using, for example, object content identification (OCI) 507. The TGS 502 can execute one or more requests associated with a call from the TAM server 504, such as, without limitation, call handling, TTS, playback/record, downloading/uploading files to and from a messages server (e.g., using HTTP protocol), fax receive, and other requests. The TAM server 504 and the TGS 502 can communicate using a telephony gateway interface protocol 505 (“TGI”). In some implementations, the TAM server 504 can communicate with the TGS 502 regarding the status (e.g., availability of the call database 506), and in response, the TGS 502 can establish one or more calls based on the status.

The fault monitor server 516 coupled to the call database 506 can communicate with the TGS 502 or other servers in the call database bypass system 500 using, for example, user database protocol 519 (UDP) to identify any potential server or database failure in the call database bypass system 500 (e.g., by sending a message to the server or database or to a system administrator in the form of an email). The fault monitor server 516 can communicate with the call database 506 using, for example, OCI 521. One or more servers (e.g., TAM server 504 and TGS 502) also can be connected to the call database 506 using XPDB library (windows, COM) based on OCI.

During operation, when the TGS 502 receives an incoming call, the TGS 502 can retrieve call support information from the call database 506 (e.g., through the telephony answering machine server 504) that can be used to establish the call. If, however, the call database 506 fails or otherwise becomes unavailable, the fault monitor server 516 can detect the failure (e.g., in advance or concurrent with receiving the incoming call request), and notify the telephony answering machine serve 504, which then can communicate the unavailability status of the call database 506 to the TGS 502. When the TGS 502 receives an incoming call, the database fault manager 508 associated with the TAM server 504 can automatically bypass the call database 506. The TGS 502 can then establish the call using default configuration and call routing information. The call details can be logged in a different or backup database (e.g., database 512 of the SIP proxy server 510) using, for example, MySQL scripts, or stored in internal or cached memory until the call database 506 is repaired and/or restored. After the call database 506 is back in service, information associated with the call that are stored in the backup database can be automatically or manually forwarded or transferred to the call database 506.

### Generic Computing Devices

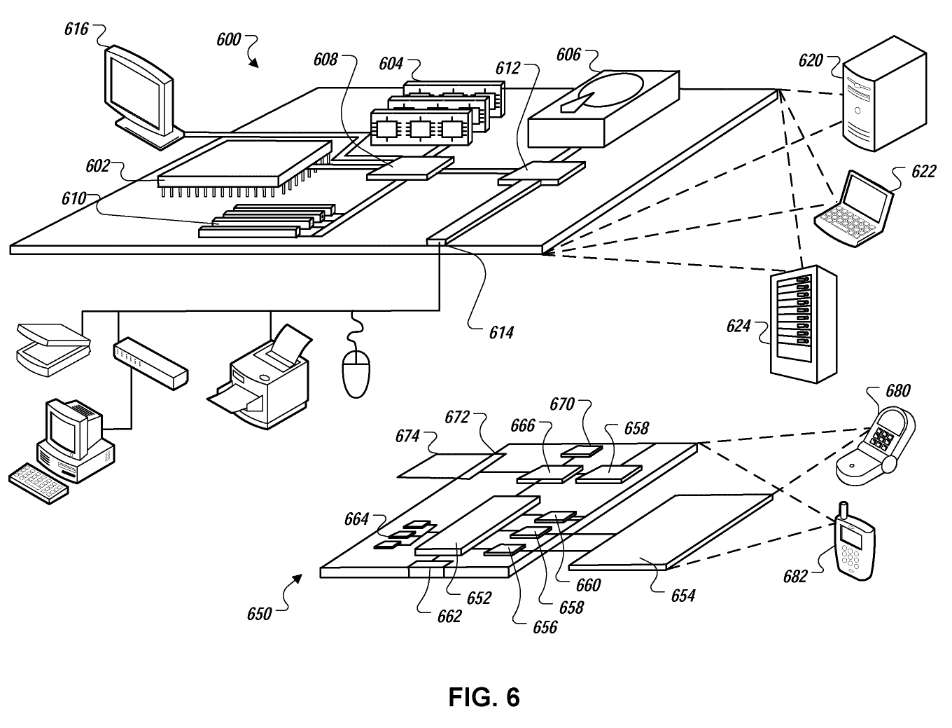

FIG. 6 is a block diagram of two computing devices that can be used to implement processes and methods described in relation to the call management system shown in FIG. 1. Computing device 600 can represent various forms of digital computers, such as laptops, desktops, workstations, personal digital assistants, servers, blade servers, mainframes, and other appropriate computers (e.g., user terminal 126). Computing device 650 can represent various forms of mobile devices, such as personal digital assistants, cellular telephones, smartphones, and other similar computing devices used to place or receive the calls. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and can be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses can be used, as appropriate, along with multiple memories and types of memory. Also, multiple computing devices 600 can be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 can be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which can accept various expansion cards (not shown). In the implementation, low-speed controller 612 is coupled to storage device 606 and low-speed expansion port 614. The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 600 can be implemented in a number of different forms, as shown in the figure. For example, it can be implemented as a standard server 620, or multiple times in a group of such servers. It can also be implemented as part of a rack server system 624. In addition, it can be implemented in a personal computer such as a laptop computer 622. Alternatively, components from computing device 600 can be combined with other components in a mobile device (not shown), such as device 650. Each of such devices can contain one or more of computing device 600, 650, and an entire system can be made up of multiple computing devices 600, 650 communicating with each other.

Computing device 650 includes a processor 652, memory 664, an input/output device such as a display 654, a communication interface 666, and a transceiver 668, among other components. The device 650 can also be provided with a storage device, such as a microdrive or other device, to provide additional storage. Each of the components 650, 652, 664, 654, 666, and 668, are interconnected using various buses, and several of the components can be mounted on a common motherboard or in other manners as appropriate.

The processor 652 can process instructions for execution within the computing device 650, including instructions stored in the memory 664. The processor can also include separate analog and digital processors. The processor can provide, for example, for coordination of the other components of the device 650, such as control of user interfaces, applications run by device 650, and wireless communication by device 650.

Processor 652 can communicate with a user through control interface 658 and display interface 656 coupled to a display 654. The display 654 can be, for example, a TFT LCD display or an OLED display, or other appropriate display technology. The display interface 656 can comprise appropriate circuitry for driving the display 654 to present graphical and other information to a user. The control interface 658 can receive commands from a user and convert them for submission to the processor 652. In addition, an external interface 662 can be provide in communication with processor 652, so as to enable near area communication of device 650 with other devices. External interface 662 can provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 can also be provided and connected to device 650 through expansion interface 672, which can include, for example, a SIMM card interface. Such expansion memory 674 can provide extra storage space for device 650, or can also store applications or other information for device 650. Specifically, expansion memory 674 can include instructions to carry out or supplement the processes described above, and can include secure information also. Thus, for example, expansion memory 674 can be provide as a security module for device 650, and can be programmed with instructions that permit secure use of device 650. In addition, secure applications can be provided via the SIMM cards, along with additional information, such as placing identifying information on the SIMM card in a non-hackable manner.

The memory can include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 can communicate wirelessly through communication interface 666, which can include digital signal processing circuitry where necessary. Communication interface 666 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 668. In addition, short-range communication can occur, such as using a Bluetooth, WiFi, or other such transceiver (not shown). In addition, GPS receiver module 1270 can provide additional wireless data to device 650, which can be used as appropriate by applications running on device 650.

Device 650 can also communication audibly using audio codec 660, which can receive spoken information from a user and convert it to usable digital information. Audio codex 660 can likewise generate audible sound for a user, such as through a speaker, e.g., in a handset of device 650. Such sound can include sound from voice telephone calls, can include recorded sound (e.g., voice messages, music files, etc.) and can also include sound generated by applications operating on device 650.

The computing device 650 can be implemented in a number of different forms, as shown in the figure. For example, it can be implemented as a cellular telephone 680. It can also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications can be made without departing from the spirit and scope of the invention. For example, various forms of the flows shown above can be used, with steps re-ordered, added, or removed. Also, although several applications of the search systems and methods have been described, it should be recognized that numerous other applications are contemplated. Accordingly, other implementations are within the scope of the following claims.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications can be made without departing from the spirit and scope of the invention. For example, the examples were given in C programming language. However, the programmable compiler can be implemented for any imperative computer programming language. Also, the function exp was given to illustrate the efficiency of a reduced accuracy routine. Other mathematical functions can be written to increase efficiency from the standard functions. Accordingly, other implementations are within the scope of the following claims.

A number of implementations of the invention have been described. Nevertheless, it will be understood that various modifications can be made without departing from the spirit and scope of the invention. Accordingly, other implementations are within the scope of the following claims.

What is claimed is:

1. A method comprising:
receiving a request to establish a call;
identifying a call database containing call information supporting the call;
determining an availability of the call database; and
establishing the call without accessing the call information in the call database if it is determined that the call database is unavailable.

2. The method of claim 1, where determining the availability of the call database includes determining whether one or more errors are present in the call database that render the call information inaccessible from the call database.

3. The method of claim 1, where establishing the call includes routing the call to an intended recipient using default call routing parameters.

4. The method of claim 1, further comprising generating a call log including call data related to the call.

5. The method of claim 4, where generating the call log is performed in a backup database different from the call database.

6. The method of claim 5, further comprising restoring the call database if the call database is unavailable.

7. The method of claim 6, further comprising forwarding the call log from the backup database to the call database upon restoring the call database.

8. The method of claim 4, where generating the call log includes recording information selected from at least one of a calling number, a destination number, a call duration or a call time associated with the call.

9. The method of claim 1, where determining the availability of the call database is available is performed before receiving the request to establish the call.

10. A system comprising:
a telephone gateway server to receive one or more requests to establish one or more calls;
a call database containing call information supporting the one or more calls; and
a fault monitor server to detect one or more errors at the call database and to communicate the one or more identified errors to the telephone gateway server; and
a telephony answering server to communicate with the telephony gateway server to establish the one or more calls without accessing the call information in the call database if the fault monitor server detects one or more errors at the call database.

11. The system of claim 10, where the telephony answering server accesses the call information supporting the one or more calls from the call database if no error is detected at the call database, and communicates the call information to the telephone gateway server for establishing the one or more calls using the call information.

12. The system of claim 11, further comprising a SIP proxy server configured to record call data related to the one or more calls, and store the recorded call data in a backup database.

13. The system of claim 12, where the SIP proxy server is configured to forward the recorded call data stored in the backup database to the call database.

14. The system of claim 13, where the recorded call data is forwarded to the call database only when the call database is available.

15. The system of claim 14, where the call database is available when no error is detected at the call database.

16. The system of claim 12, where the SIP proxy server includes an active SIP proxy server and a standby SIP proxy server, where the standby SIP proxy server is activated when the active proxy server fails to record the call data related to the one or more calls.

17. The system of claim 10, where the telephone gateway server receives session initiation protocol (SIP) information associated with the one or more calls from a SIP proxy server, and to identify call information associated with the SIP information in the call database.

18. The system of claim 10, where the fault monitor server communicates the one or more identified errors to the telephone gateway server through the telephony answering server using one or more messages.

19. A device comprising:
a call database that stores call information supporting one or more calls; and
a call control manager that:
receives the one or more requests to establish the one or more calls;
determines the availability of the call database; and
establishes the one or more calls without accessing the call information in the call database if the call database is unavailable.

20. The device of claim 19, where the call control manager completes the one or more outbound calls using default call routing information.
